(19) United States
(12) Patent Application Publication
(10) Pub. No.: US 2008/0102237 A1
(43) Pub. Date: May 1, 2008

(54) Method And Device For Producing A Profiled Bar

(75) Inventors: Cyrille Ortegat, Noyon (FR); Guy Leclercq, Cambronne Les Ribecourt (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-OBAIN GLASS FRANCE, Courbevoie (FR)

(21) Appl. No.: 11/576,089

(22) PCT Filed: Sep. 26, 2005
(86) PCT No.: PCT/FR05/50781

§ 371 Date: Aug. 8, 2007

(30) Foreign Application Priority Data
Sep. 27, 2004 (FR) 0452163

(51) Int. Cl. B29C 47/02

(52) U.S. Cl. 428/38; 264/279; 425/516

(57) ABSTRACT

The invention relates to a method for manufacturing a profiled flexible bead (1) in a polymer material on a glazing (2) by encapsulation, the said device comprising a step of moulding, having brought at least one moulding element (3, 3′) into contact with the said glazing (2), by means of at least one sealing system (4), characterized in that at least one vent is formed inside the said sealing system (4).

The present invention relates to a method for manufacturing a profiled flexible bead in a polymer material on a glazing by encapsulation, the said method comprising a step of moulding, having brought at least one moulding element into contact with the said glazing by means of at least one sealing system, and to a device or implementing this method and to the glazing obtained by implementing this method.

It relates more particularly to the production of the vents which allow the air present in the moulding elements during the encapsulation moulding of a flexible bead made of polymer material to be discharged, thus enabling a uniform distribution of the moulded polymer in the moulding element. The term “encapsulation ” within the meaning of this invention is to be understood as meaning the use of a technique of injecting material into a closed-mould system, it being understood that the flexible bead may be formed over all or part of the periphery of the glazing or on any part of the glazing.

Indeed, in the absence of at least one vent, the encapsulation-moulded polymer runs the risk of exhibiting a profile that does not precisely correspond to the inverse of the cavity of the moulding elements or runs the risk of exhibiting roughnesses or bubbles.

It is thus known in the prior art to produce controlled air leaks, particularly at the parting line of the moulding elements, but these air leaks are often accompanied by leakage of material. This excess material has subsequently to be removed during a flash-removal operation which leads to a significant loss of time and requires a great deal of manpower because it is an operation that can be automated only with difficulty. It is not conceivable to let this material because the parting line of the moulding elements is always in vincinity of the lateral edge of the glazing and thus this material would be visible when mounting the glazing in the opening it has to close.

It is, also, known to produce a sprue-vent channel by causing the air and the surplus material to discharge into a special volume of the mould, even in the moulding cavity as in document JP 05084778, but this sprue has then to be removed from the mould before the next flexible bead can be moulded. This operation also generates a loss of time and also requires manpower because it is an operation that can be automated only with difficulty.

It is also known practice in the prior art to position on the glazing a strip of material that adheres to the glazing and to make a vent at this strip so that the excess material becomes deposited on this strip and is subsequently easier to remove. However, this solution also leads to a loss of time in sticking down the adhesive strip and removing it and also requires manpower because it is an operation that can be automated only with difficulty.

The object of the invention is to alleviate the disadvantages of the prior art by proposing a method that makes it possible to produce at least one vent without causing a loss of time or, at the least, while reducing the losses of time, both in the moulding and in the subsequent finishing. By virtue of the method according to the invention, the encapsulation operation can be automated more readily and the producing of the vents in itself generates neither a loss of time nor an additional manual flash-removal operation

The present invention thus relates in its broadest sense to a method for manufacturing a profiled flexible bead in a polymer material on a glazing by encapsulation, the said method comprising a step of moulding, having brought at least one moulding element into contact with the said glazing, by means of at least one sealing system, characterized in that at least one vent is formed inside the said sealing system.

This vent could be at an extremity in direct contact with atmosphere exterior to the mold cavity in which the profile bead is formed or could constitute a simple closed cavity for the welcome of the air during the molding, the air being thus compressed in this cavity by the progression of the material in the moulding cavity; however according to the invention the vent is realized in the interior of the sealing system, in contac with the glazing; il is thus not realized in the interior of the cavity molding.

This vent (or these vents) is (are) preferably formed between a plurality of lips of the sealing system at least one of this lip being interrupted and/or having at least one hole and/or being more supple than at least one other.

When a vent is produced between several lips, at least two lips are preferably more or less parallel or coaxial.

Prior to moulding the flexible bead, each zone of the glazing in which a vent is produced is preferably prepared so that any excess material that forms in the region of a vent adheres to the glazing. This adhesion is preferably identical to the adhesion of the flexible bead to the glazing.

This preparation can be done either by applying an adhesion primer, or by applying an adhesive strip.

One particular feature of the method according to the invention is that the production parameters for the said flexible bead are constant throughout a production run, that is to say that injection is performed at constant volume or constant weight and at the same pressure from one flexible bead to the next. It is therefore no longer necessary, as it was before during a production run (same glazing, same flexible bead) to adjust the quantity or pressure of the material to be injected, particularly when dimensional discrepancies show up on the glazings. These discrepancies now have no impact on the flexible bead itself. They simply cause a greater or lesser amount of flash at the vent or at each vent.

This excess material that forms in the region of a vent or in the region of each vent is not removed after the manufacturing of the profile bead, before delivery to the client or before monting in the opening it has to close.

When the method according to the invention is implemented for producing a flexible bead on a glazing intended to be mounted on any vehicle and in particular automobile vehicle, the said glazing at least partially having a decorative strip of the attached strip of coloured material (enamel) or strip of coloured material incorporated into the substrate type, the vent (or vents) is (are) at least partially, and preferably wholly, produced behind the said decorative layer when the vehicle is viewed from the outside looking in. Thus, the surplus material escaping through this (these) vent(s) will be concealed from the outside, at least partially and preferably wholly, by the decorative strip. This material will further be in general concealed from the interior of the vehicle by ornamental edges.

On this premise also, prior to the moulding of the flexible bead, at least one reinforcing or fixing insert may be positioned in a moulding element so that the flexible bead formed subsequently incorporates this insert at least.

The present invention also relates to a device for manufacturing a profiled flexible bead made of a polymer material on a glazing by encapsulation, the said device comprising at least one moulding element brought into contact with the said glazing by means of at least one sealing system, characterized in that the said sealing system comprises means for producing at least one vent within the said sealing system.

In the device according to the invention, the said sealing system preferably comprises at least one annular seal or a plurality of seal portions forming an annulus, the said system thus exhibiting an axis A.

The said means for producing at least one vent preferably consist of a plurality of lips at least one of which is interrupted and/or has at least one hole and/or is more supple than at least one other.

This lip that is interrupted and/or has at least one hole and/or is more supple than at least one other is preferably situated closest to the said flexible bead with respect to the other lip(s).

When the said means for producing at least one vent consist of a plurality of lips, at least two lips are preferably more or less parallel, or coaxial when they are annular.

The said sealing system preferably comprises at least one groove, which is annular when the sealing system is annular, this groove having, in cross section, the shape of a V or U for example, the opening of which faces towards the glazing. It is in this groove that the vent is produced, that is to say that it is in this groove that the air expelled by the material injected into the moulding cavity will be compressed and that the excess material will spread out and adhere to the glazing.

When the glazing at least partially has a decorative strip, the said means for producing at least one vent are preferably positioned at least partially behind the said decorative strip at the time of injection, so that the excess material can be produced at least partially and preferably wholly behind the decorative strip when the vehicle is viewed from the outside looking in.

The said means for producing at least one vent are preferably positioned at a location opposed with respect to at least one or each) injection nozzle via which the material that forms the flexible bead is injected into the said moulding element at least. The expression “opposed with respect to” here is to be understood as meaning:
when the nozzle is positioned at one longitudinal end of a longitudinal moulding cavity “opposed with respect to” denotes the other longitudinal end;
when the nozzle is positioned in the middle of a longitudinal moulding cavity, “opposed with respect to” denotes one longitudinal end;
when the moulding cavity is annular, “opposed with respect to” denotes a position approximately 180° removed from the nozzle about the axis of the annulus.

The present invention also relates to a glazing having at least one profiled flexible bead made of a polymer material obtained by encapsulation by implementing the method according to the invention or by using the device according to the invention

The flexible bead of the glazing thus produced thus comprises when delivering to the client and by consequence also when and after mounting in the opening it has to close, at least one excess of material corresponding to the site where the said vent at least was produced.

In the case of a glazing for a vehicle, this excess material is preferably positioned on a side of the glazing intended to faces and effectively facing after mounting of the glazing in the opening, the inside of the motor vehicle.

In the case of a glazing for a vehicle also, when the said glazing at least partially has a decorative strip of the attached strip of coloured material (enamel) or strip of coloured material incorporated into the substrate type, the said excess material is at least partially positioned behind the said decorative strip and preferably positioned wholly behind this strip, when the vehicle is viewed from the outside looking in.

In the case of a glazing for a vehicle also, the flexible bead may comprise at least one insert, or even several inserts, for fixing the glazing in place or reinforcing it or for the fixation of accessories.

In the case also of a glazing that only partially has a decorative layer, that is to say has a decorative layer not over the entire surface of the glazing equipped with a flexible bead, the said excess material may be at least partially positioned behind a facing when the vehicle is viewed from the inside looking out.

A glazing within the meaning of the present invention is to be understood as meaning any glass or plastic panel that is monolithic or multiple, that is to say formed of one or several sheets of material.

According to the invention, a use of this glazing could be realized for closing an opening and in particular an opening in a body of a vehicle and particularly of an automobile vehicle.

This use is realized without prior removing of the excess material that forms in the region of the vent(s).

Advantageously, the present invention thus makes it possible to produce one (or several) controlled venting zone(s) in one (or several) specifically chosen zone(s) of the glazing and which will not be visible or will be visible only slightly on the glazing once installed.

Advantageously also, the vent(s) is (are) thus produced on a side of the glazing in an element guiding the excess material, actually inside a seal.

The excess material generated for each vent can thus be concealed behind a decorative strip and therefore does not affect the aesthetic characteristics of the glazing.

It may also be concealed behind a facing, particularly when no decorative strip is provided.

This excess material does not affect the mechanical properties of the flexible bead either, because it adheres to the glazing in the same way as the flexible bead.

Thus, the excess material may be left on the glazing and there is therefore no need to remove it before delivering to the client and before mounting in the opening it has to close.

Time is saved prior to moulding because there is no need to carry out a special operation for preparing the vent: all that is required is for the glazing zone near the vent is situated to be prepared in the same way as the zone of the glazing to which the flexible bead is to adhere.

Time is also saved after moulding because there is no need to carry out any flash-removal.

Advantageously too, the method according to the invention is compatible with all materials customarily used for performing encapsulation techniques.

The present invention will be better understood upon reading the detailed description hereinafter of some non-limiting exemplary embodiments and from studying the attached figures:

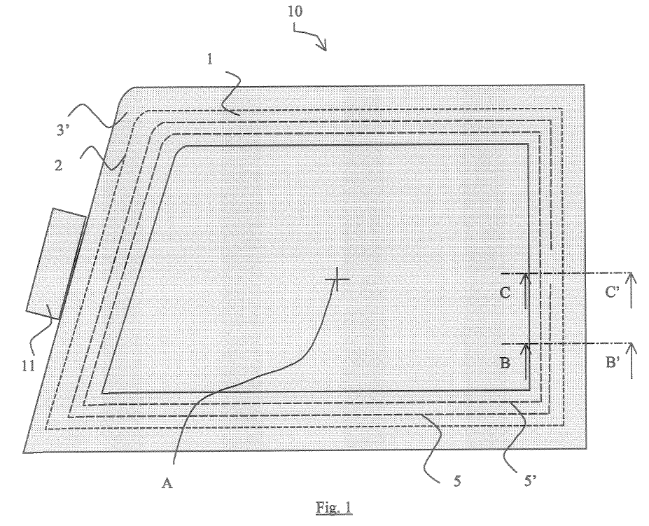

FIG. 1 illustrates a simplified view from beneath of a moulding device according to the invention, on a horizontally-orientated glazing, the view being taken at the underside of the glazing;

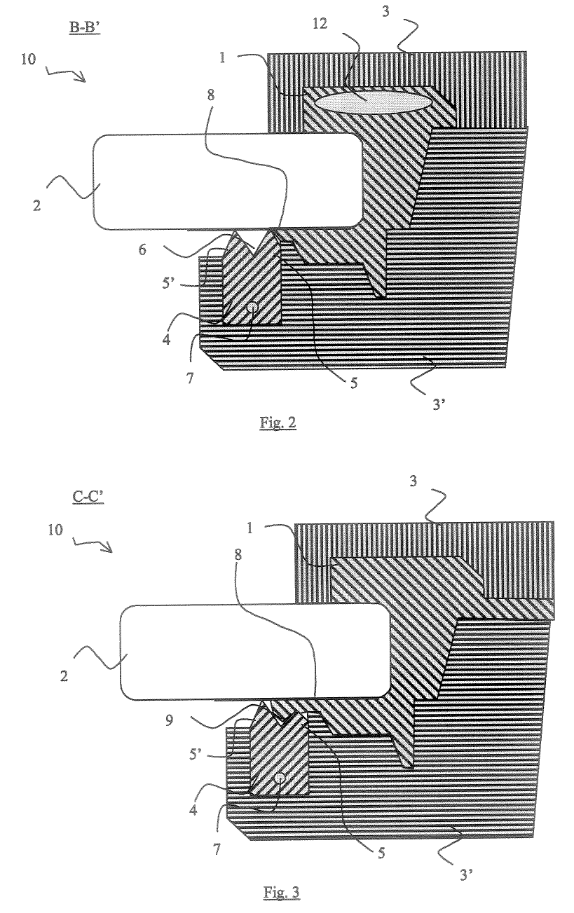

FIG. 2 illustrates a view in section on B′ of FIG. 1; and

FIG. 3 illustrates a view in section on C-C′ of FIG. 1.

In order to make the figures easier to understand, these figures are not drawn strictly to scale.

FIG. 1 illustrates a glazing (2) on which a profiled flexible bead (1) made of a polymer material is produced.

The polymer material of which the flexible bead (1) is made may be a thermoplastic (PVC, TPF, etc.), a polyurethane or alternatively a synthetic rubber of the EPDM type or any other suitable material.

The method of manufacture of the flexible bead (1) is termed “encapsulation” because it involves a step of moulding the flexible bead (1) in a moulding device (10) between two moulding elements, an upper moulding element (3) and a lower moulding element (3′), as can be seen in FIG. 2.

In the figures, the flexible bead (1) is arranged around the entire periphery of the glazing (2) but this flexible bead could perfectly well be positioned on only part of the periphery of the glazing or on any part of the glazing.

Each moulding element is closed around the glazing (2) by virtue of a sealing system (4); however, for greater clarity, only the sealing system (4) for the lower moulding element (3′) has been depicted.

It is these sealing systems which make it possible to maintain sufficient pressure inside the mould while the polymer material is being injected.

These sealing systems also make it possible, to a certain extent, to “compensate” for the manufacturing and tolerances on the glazing, that is to say to compensate for any discrepancies that may arise on the nominal dimensions of the glazing within the mould.

Each sealing system constitutes an annular seal, positioned at the periphery of the glazing and has an axis A, in this instance directed vertically because injection is performed onto a glazing positioned horizontally; however, the axis A could also be orientated horizontally if injection is performed onto a glazing positioned vertically, or orientated in any other way.

According to the invention, in order to allow the air to escape from the moulding cavity of the moulding elements closed onto the glazing when the material that constitutes the flexible bead is being injected, at least one vent is formed inside the said sealing system (4).

It is recalled here that the injection pressure is often in the region of a few bars to a few tens of bars, particularly for PU-RIMs, but may also be as much as a few hundred bars, particularly for PVC (poly(vinylchloride)) resins.

Of course, this (or these) vent(s) also allows (allow) a small amount of excess material to escape from the moulding cavity for moulding the flexible bead without in any way leaving the sealed enclosure and more specifically the enclosure defined by the sealing system (4) in its entirety. The excess material (9) escaping in this way into the vent is illustrated in FIG. 3

To do this, the sealing system (4) of the lower moulding element (3′) comprises means for producing at least one vent within the said sealing system (4). It is these means that will guide the excess material (9) to make it spread out where it is wanted, actually within the sealing system (4).

These means may originate from an additional operation performed after the manufacture of the seal, particularly when the seal is extruded, or may originate from the very operation of manufacturing the seal, particularly when the seal is produced by moulding.

The sealing system (4) may, for example, be made of silicone.

In the version of the invention illustrated here, the means for producing at least one vent consist of a plurality of lips (5, 5′) which are parallel, and more specifically coaxial, because the sealing system (4) is annular, of which one, the lip (5) situated axially closest to the said flexible bead (1) is interrupted: it exhibits a portion which is no longer in contact with the glazing, via which portion the air expelled by the injected material passes into the sealing system (4) and via which the excess material also passes into the sealing system (4).

In an alternative form it might equally have been possible for this outer lip to be equipped with at least one hole or with a plurality of holes for the passage of the air and the excess material.

In the version of the invention illustrated here, the lips (5, 5′) have a more or less triangular cross section and meet at their base. An annular V-shaped groove (6) is thus formed between the two lips (5, 5′). However, it is possible to conceive of other cross sections for the groove (6), particularly a U-shaped cross section. It is also possible that the bottom of the groove is in contact directly or indirectly (by the mean of a flapgate or a filter) with the atmosphere exterior to the mold.

It is also possible to produce the groove (6) on only part of the sealing system comprising means for producing at least one vent at the point(s) where the vent(s) is (are) to be produced. Thus, the cross section of the groove may have a maximum value at the interruption of the lip axially closest to the said flexible bead (1) and/or at the holes formed in this lip which is axially closest to the said flexible bead (1) and then diminish down to a zero value with increasing distance away from this interruption and/or from these holes, after a few centimetres.

Furthermore, in the version of the invention illustrated here, the lips (5, 5′) constitute upper vertical extensions of the sealing system (4) of the lower moulding element (3′), but it is entirely possible to make the two lips (5, 5′) completely independent. In this latter variant in particular, it is preferable to produce the lip (5) situated axially closest to the said flexible bead (1) more supple than the other, so as to facilitate the passage of the air and of the excess material (9) into the groove (6) situated between the two lips and so as to prevent this air and this excess material from escaping from the sealing system (4).

A hole having a cylindrical cross section (7) may also be produced right along all or a part of the seal system (4) to facilitate the deformation of the latter while at the same time ensuring the desired level of sealing.

As can be seen from FIG. 1, the vent is preferably positioned at a location opposed with respect to the injection nozzle (11) via which the material of which the flexible bead (1) is made is injected into the mould. More specifically, with the flexible bead being annular and more or less symmetric about its axis, the vent is positioned more or less at a location opposed to the region at which the material is injected, where the flux or fluxes arriving from each side meet. It may also be preferable to produce several vents even when just one injection nozzle is used, especially when the mould cavity extends over a long length.

Prior to moulding the flexible bead (1), each region of the glazing (2) in which a vent is produced is prepared so that the excess material (9) adheres to the glazing (2) just like the flexible bead (1) adheres to the glazing (2).

The glazing (2) is preferably at least partially transparent and may be a monolithic glazing, that is to say one consisting of a single sheet of material, or may be a multiple glazing, that is to say one formed of several sheets of material between which at least one layer of adhesive material is inserted in the case of laminated glazings, or at least one interlayer space is inserted in the case of double glazing. The sheets of material may be inorganic in nature, particularly made of glass, or organic, particularly made of plastic.

In the case of a glazing for a vehicle, the glazing generally at least partially has, at its periphery, a decorative strip (8). This decorative strip generally results from a deposit of enamel, produced on the inside of the glazing or on an interlayer face of the glazing in the case of composite glazing, but can also result from a partial and/or peripheral coloration of a sheet of material used, particularly a sheet made of an organic material. In this case, the vent (or vents) is (are) produced behind the said decorative strip (8) so that the excess material (9) is concealed by the decorative strip (8). To do this, the means for producing at least one vent are positioned at least partially under the said decorative strip (8) because the glazing is positioned horizontally and the flexible bead (1) is produced essentially under the glazing (2) in the version illustrated.

The excess material (9) is thus also produced on the side of the glazing intended to face the inside of the vehicle.

The vents could just as easily be produced at points other than under the decorative strip: in regions of the glazing which will be concealed once the glazing has been fitted.

In the case of a glazing for a vehicle also, it is possible to position one (or several) insert(s) (12) in the moulding element (3, 3′) prior to the moulding of the flexible bead (1) so that the flexible bead incorporates this (these) insert(s).

This (or these) insert(s) may be one (or more) reinforcing insert(s) generally completely incorporated into the flexible bead (1) as can be seen in FIG. 2, or may be one (or more) fixing insert(s), generally protruding, for securing the glazing or an accessory.

The glazing (2) such as can be seen in FIGS. 2 and 3, having a profiled flexible bead (1) made of a polymer material and excess material (9) corresponding to the location where the vent has been produced, is then delivered in that state to the customer once it has been removed from the mould. No flash-removal operation is carried out when it leaves the mould before it is delivered to the customer and before it is mounted in the opening.

The present invention is described in the foregoing by way of example. It is understood that the person skilled in the art is capable of producing various variants of the invention without thereby departing from the scope of the patent as defined by the claims

1. Method for manufacturing a profiled flexible bead (1) in a polymer material on a glazing (2) by encapsulation, the said method comprising a step of moulding, having brought at least one moulding element (3, 3′) into contact with the said glazing (2) by means of at least one sealing system (4), characterized in that at least one vent is formed inside the said sealing system (4).

2. Method according to the preceding claim, characterized in that the vent is formed between a plurality of lips (5, 5′) at least one of which is interrupted and/or has at least one hole and/or is more supple than at least one other.

3. Method according to the preceding claim, characterized in that at least two lips (5, 5′) are more or less parallel or coaxial.

4. Method according to any one of the preceding claims, characterized in that with the said glazing (2) at least partially having a decorative strip (8), the vent is produced at least partially behind the said decorative strip (8).

5. Method according to any one of the preceding claims, characterized in that the production parameters for the said flexible bead (1) are constant throughout a production run.

6. Method according to any one of the preceding claims, characterized in that prior to moulding the flexible bead (1), each zone of the glazing (2) in which a vent is produced is prepared so that any excess material (9) that forms in the region of a vent adheres to the glazing (2).

7. Method according to any one of the preceding claims, characterized in that any excess material (9) formed in the region of a vent is not removed after the manufacturing of the profiled flexible bead (1).

8. Method according to any one of the preceding claims, characterized in that prior to moulding the flexible bead (1), at least one insert (12) is positioned in a moulding element (3, 3′).

9. Device (10) for manufacturing a profiled flexible bead (1) made of a polymer material on a glazing (2) by encapsulation the said device comprising at least one moulding element (3, 3′) brought into contact with the said glazing (2) by means of at least one sealing system (4), characterized in that the said sealing system (4) comprises means for producing at least one vent within the said sealing system (4).

10. Device (10) according to the preceding claim, characterized in that the said sealing system (4) comprises at least one annular seal or a plurality of seal portions forming an annulus.

11. Device (10) according to claim 9 or claim 10, characterized in that the said means for producing at least one vent consist of a plurality of lips (5, 5′) at least one of which is interrupted and/or has at least one hole and/or is more supple than at least one other.

12. Device (10) according to the preceding claim, characterized in that the said lip (5) that is interrupted and/or has at least one hole and/or is more supple than at least one other is situated closest to the said flexible bead (1).

13. Device (10) according to either one of claims 11 and 12, characterized in that at least two lips (5, 5′) are more or less parallel or coaxial.

14. Device (10) according to any one of claims 9 to 13, characterized in that the said sealing system (4) comprises at least one groove (6).

15. Device (10) according to any one of claims 9 to 14, characterized in that with the said glazing (2) at least partially having a decorative strip (8), the said means for producing at least one vent are at least partially positioned behind the said decorative strip (8).

16. Device (10) according to any one of claims 9 to 15, characterized in that the said means for producing at least one vent are positioned at a location opposed with respect to at least one injection nozzle (11) via which the material that forms the flexible bead (1) is injected into the said moulding element (3, 3′) at least.

17. Glazing (2) having at least one profiled flexible bead (1) made of a polymer material obtained by encapsulation by implementing the method according to any one of claims 1 to 8, characterized in that the said flexible bead (1) comprises at least an excess of material (9) corresponding to the location where the said vent at least has been produced.

18. Glazing (2) according to the preceding claim, characterized in that the said excess material (9) is positioned on a side of the glazing intended to face the inside of a vehicle.

19. Glazing (2) according to claim 17 or claim 18, characterized in that with the said glazing (2) at least partially having a decorative strip (8), the said excess material (9) is at least partially positioned behind the said decorative strip (8).

20. Glazing (2) according to any one of claims 17 to 19, characterized in that the said excess material (9) is at least partially positioned behind a facing.

21. Glazing (2) according to any one of claims 17 to 20, characterized in that the said flexible bead (1) comprises at least one insert (12).

22. Use of a glazing (2) according to any one of claims 17 to 21 to close an opening and in particular an opening in a vehicle body.
